(19) United States
(12) Patent Application Publication
(10) Pub. No.: US 2024/0179816 A1
(43) Pub. Date: May 30, 2024

(54) HIGH-VOLTAGE INPUT POWER SUPPLY LINE APPLICABLE TO LIGHT-EMITTING LOAD

(71) Applicant: Shaohong Lu, Shangrao (CN)

(72) Inventor: Shaohong Lu, Shangrao (CN)

(21) Appl. No.: 18/436,055

(22) Filed: Feb. 8, 2024

(51) Int. Cl. H05B 45/37; H05B 45/46

(52) U.S. Cl. CPC H05B 45/37; H05B 45/46

(57) ABSTRACT

The present disclosure discloses a high-voltage input power supply line applicable to a light-emitting load. The present disclosure adopts a combination of high-level inputting and low-voltage loading, which not only achieves long-distance transmission, but also solves the problem of poor low-voltage loading capacity. If a high voltage is completely used, the cost is high, and safety accidents such as electric shock and leakage are easily caused. Therefore, the power supply line can achieve wireless extended power transmission on the premise of saving the cost and ensuring the electrical safety.

### TECHNICAL FIELD

The present disclosure relates to the technical field of control of light-emitting loads, and in particular, to a high-voltage input power supply line applicable to a light-emitting load.

### BACKGROUND

Recently, with the continuous development and progress of the society, more and more attentions are paid to outdoor lighting projects for buildings in various regions, landscapes, and landmarks. LED lamps have been widely applied in various decoration and advertisement industries due to their advantages of high light efficiency and low energy consumption. For example, a large number of light bars are required to be arranged on an exterior wall of a building, and the light bars need to be connected in parallel together during on-site mounting.

However, as more and more load LED lamp strings are connected in parallel, a power transmission line also becomes longer, and the impedance of the power transmission line increases, which means that a voltage shared by the power transmission line increases. This leads to an insufficient power supply voltage for load LED lamp strings connected in parallel later, so that the load LED lamps strings connected in parallel later emit dark light.

### SUMMARY

The present disclosure aims to provide a high-voltage input power supply line applicable to a light-emitting load to solve the above problems. Details are as follows.

In order to achieve the above objectives, the present disclosure provides the following technical solutions:

The present disclosure provides a high-voltage input power supply line applicable to a light-emitting load. The power supply line is composed of a plurality of voltage reduction modules which are cascaded, wherein an input of each voltage reduction module is an operation control signal of a positive electrode and negative electrode of a high-voltage power supply and the previous voltage reduction module, wherein each voltage reduction module includes a voltage reduction circuit and a plurality of cascaded light-emitting loads connected to the voltage reduction circuit; and each light-emitting load includes a light-emitting control module and a light-emitting module.

By the adoption of the high-voltage input power supply line applicable to the light-emitting load, when the plurality of cascaded light-emitting loads need to be connected in parallel to the power supply line, a high-voltage power supply module is used to output a high-level voltage that is greater than a rated voltage of the plurality of cascaded light-emitting loads, to counteract the loss of the output voltage on a power transmission line. Meanwhile, in order to enable various load LED lamps that are connected in parallel to each other to run normally, the voltage reduction modules are used to reduce the high-level voltage to a low-level voltage. The embodiments of the present disclosure adopt a combination of high-level inputting and low-voltage loading, which not only achieves long-distance transmission, but also solves the problem of poor low-voltage loading capacity. If a high voltage is completely used, the cost is high, and safety accidents such as electric shock and leakage are easily caused. Therefore, wireless extended power transmission is achieved on the premise of saving the cost and ensuring the electrical safety.

As a preference, the voltage reduction circuit is configured to convert a high-level voltage input of a high-voltage power supply into a low-level voltage output.

As a preference, an output range of the high-level voltage is 6 to 230 V.

As a preference, the low-level voltage is not less than a rated voltage of the plurality of cascaded light-emitting loads.

As a preference, an output range of the low-level voltage is 3 to 36 V.

As a preference, in all the light-emitting loads, the light-emitting control modules control circuits in the light-emitting modules to be on and off by using an I/O port of a single-chip microcomputer.

As a preference, the plurality of cascaded light-emitting loads connected to the voltage reduction circuit are in signal communication with the voltage reduction circuit; when the voltage reduction circuit receives an operation control signal of the previous voltage reduction module, the voltage reduction circuit sends the operation control signal to the plurality of cascaded light-emitting loads connected to the voltage reduction circuit, so that the light-emitting control modules in the light-emitting loads control, on the basis of the operation control signal, the light-emitting modules to be on and off.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of a high-voltage input power supply line applicable to a light-emitting load in an application embodiment;

FIG. 2 is a schematic structural diagram of a high-voltage input power supply line applicable to a light-emitting load in another application embodiment;

FIG. 3 is a schematic structural diagram of a high-voltage input power supply line applicable to a light-emitting load in still another application embodiment; and

FIG. 4 is a schematic structural diagram of a high-voltage input power supply line applicable to a water pipe lamp in an application embodiment.

### DESCRIPTIONS OF REFERENCE NUMERALS

voltage reduction module (1), voltage reduction circuit (11), light-emitting load (12), operation control signal (2), and high-voltage level (3).

### DETAILED DESCRIPTION OF THE EMBODIMENTS

In order to make the objectives, technical solutions, and advantages of the present disclosure clearer, a detailed description of the technical solutions of the present disclosure will be provided below. Apparently, the described embodiments are merely some embodiments of the present disclosure, rather than all of the embodiments. All other implementations obtained by a person of ordinary skill in the art based on the embodiments of the present disclosure without creative efforts shall fall within the protection scope of the present disclosure.

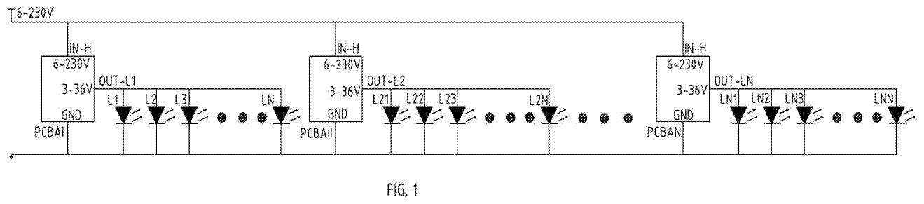

As shown in FIG. 1, the embodiments of the present disclosure provide a high-voltage input power supply line applicable to a light-emitting load. The power supply line is composed of a plurality of voltage reduction modules (1) which are cascaded to each other, wherein each voltage reduction module includes a voltage reduction circuit (11) and a plurality of cascaded light-emitting loads (12) connected to the voltage reduction circuit. The voltage reduction circuit (11) is configured to reduce an input high-level voltage to a low-level voltage and output the low-level voltage to the plurality of cascaded light-emitting loads (12), and the low-level voltage is not less than a rated voltage of the plurality of cascaded light-emitting loads (12); and the rated voltages of the plurality of cascaded light-emitting loads that are connected in parallel to each other in the same voltage reduction module should be consistent.

Each of the plurality of cascaded light-emitting loads (12) includes a light-emitting control module and the light-emitting module. The light-emitting control module uses an I/O port of a singlechip microcomputer to control a circuit inside the light-emitting module to be on and off, and the light-emitting control module controls the I/O port of the singlechip microcomputer to output a signal based on an operation control signal sent by the previous voltage reduction module.

In the embodiments of the present disclosure, the plurality of cascaded light-emitting loads (12) are light-emitting diodes. For the light-emitting diodes, an output range of the high-level voltage is 6 to 230 V, and an output range of the low-level voltage is 3 to 36 V.

Specifically, when it is necessary to connect the plurality of cascaded light-emitting loads in parallel in the power supply line, the power supply line composed of the plurality of voltage reduction modules (1) that are cascaded to each other is used to supply power to the plurality of cascaded light-emitting loads. A high-voltage power supply outputs a high-level voltage to counteract the loss of the output voltage on a power transmission line. Meanwhile, in order to enable the various load light-emitting loads that are connected in parallel to each other to run normally, the voltage reduction circuits (11) are used to reduce the high-level voltage to the low-level voltage, and the low-level voltage is slightly greater than or equal to the rated voltage of the light-emitting load. The embodiments of the present disclosure adopt a combination of high-level inputting and low-voltage loading, which not only achieves long-distance transmission, but also solves the problem of poor low-voltage loading capacity. If a high voltage is completely used, the cost is high, and safety accidents such as electric shock and leakage are easily caused. Therefore, the power supply line can save the cost and ensure the electrical safety, and the plurality of cascaded light-emitting loads can be connected in parallel in the power supply line.

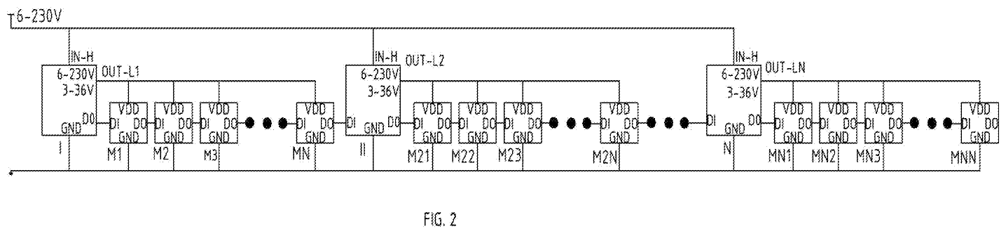

In an application embodiment, referring to FIG. 2, another high-voltage input power supply line applicable to a light-emitting load is provided. Unlike the high-voltage input power supply line applicable to the light-emitting load provided in FIG. 1, the power supply line is composed of a plurality of voltage reduction modules that are cascaded to each other, and the various voltage reduction modules are electrically connected to each other and can achieve signal intercommunication. An input of each voltage reduction module is an operation control signal of a positive electrode and negative electrode of a high-voltage power supply and the previous voltage reduction module.

Each voltage reduction module includes a voltage reduction circuit and a plurality of cascaded light-emitting loads. The plurality of cascaded light-emitting loads connected to the voltage reduction circuit can also be in signal communication with the voltage reduction circuit; when the voltage reduction circuit receives an operation control signal of the previous voltage reduction module, the voltage reduction circuit sends the operation control signal to the plurality of cascaded light-emitting loads connected to the voltage reduction circuit, so that the light-emitting control modules in the light-emitting loads control, on the basis of the operation control signal, the light-emitting modules to be on and off.

Specifically, when a first voltage reduction module receives a turning-on control signal, all the light-emitting loads connected in parallel to the first voltage reduction module can receive the turning-on control signal. Since signal communication can be achieved between all the cascaded voltage reduction modules, a second voltage reduction module, an Nth voltage reduction module, and the like can all receive the turning-on control signal. That is, the light-emitting loads connected in parallel to the second voltage reduction module, the Nth voltage reduction module, and the like can also receive the turning-on control signal, thus controlling the turning on and turning off of the light-emitting loads uniformly through signal cascading.

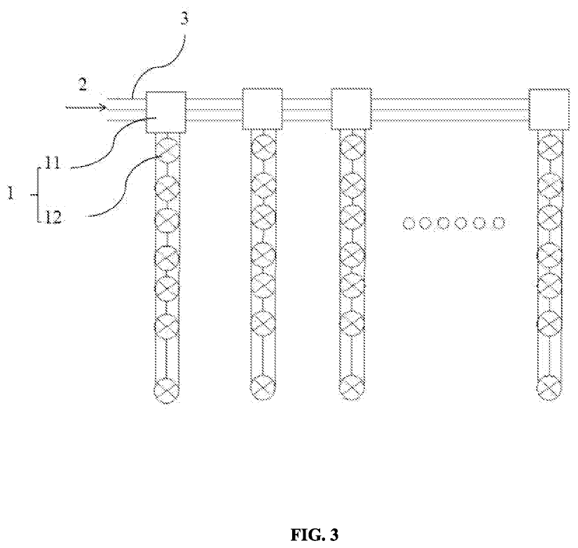

In an application embodiment, referring to FIG. 3, the embodiments of the present disclosure provide a high-voltage input power supply line applicable to a light-emitting load. The power supply line is composed of a plurality of voltage reduction modules (1) that are cascaded to each other. Each voltage reduction module includes a voltage reduction circuit (11) and a plurality of cascaded light-emitting LED lamps (12) connected to the voltage reduction circuit (11), wherein the plurality of cascaded light-emitting LED lamps (12) are arranged vertically in series. An input voltage of each voltage reduction module (1) includes a high voltage level (3) input by a high-voltage power supply and an operation control signal (2) of the previous voltage reduction module.

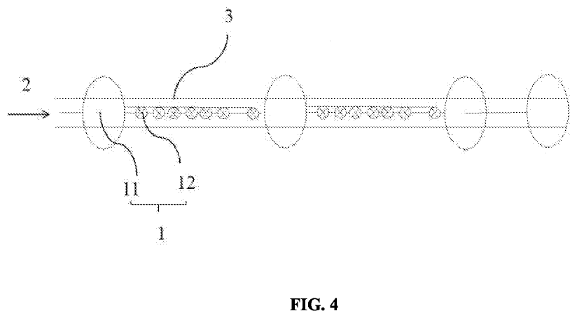

It can be understood that the high-voltage input power supply line applicable to the light-emitting load mentioned above can be applied to various kinds of LED lamp strings such as a curtain lamp and a water pipe lamp. For example, as shown in FIG. 4, the high-voltage input power supply line applicable to the light-emitting load mentioned above is applied to a water pipe lamp, that is, the light-emitting load (12) is the water pipe lamp.

In the embodiments of the present disclosure, the power supply line composed of the plurality of voltage reduction modules (1) that are cascaded to each other is used to supply power to the plurality of cascaded light-emitting loads. A high-voltage power supply outputs a high-level voltage to counteract the loss of the output voltage on a power transmission line. Meanwhile, in order to enable the various load light-emitting loads that are connected in parallel to each other to run normally, the voltage reduction circuits (11) are used to reduce the high-level voltage to the low-level voltage. A combination of high-level inputting and low-voltage loading is adopted, which not only achieves long-distance transmission, but also solves the problem of poor low-voltage loading capacity. Since the signal communication can be achieved between all the cascaded voltage reduction modules, the second voltage reduction module, the Nth voltage reduction module, and the like can all receive the turning-on control signal. That is, the light-emitting loads connected in parallel to the second voltage reduction module, the Nth voltage reduction module, and the like can also receive the turning-on control signal, thus controlling the turning on and turning off of the light-emitting loads uniformly through signal cascading.

The foregoing descriptions are merely specific implementations of the present disclosure, but are not intended to limit the protection scope of the present disclosure. Any variation or replacement easily figured out by a person skilled in the art within the technical scope disclosed in the present disclosure shall fall within the protection scope of the present disclosure. Therefore, the protection scope of the present invention shall be subject to the protection scope of the claims.

What is claimed is:

1. A high-voltage input power supply line applicable to a light-emitting load, wherein the power supply line is composed of a plurality of voltage reduction modules which are cascaded, wherein each voltage reduction module comprises a voltage reduction circuit and a plurality of cascaded light-emitting loads connected to the voltage reduction circuit; and each light-emitting load comprises a light-emitting control module and a light-emitting module.

2. The high-voltage input power supply line applicable to the light-emitting load according to claim 1, wherein the voltage reduction circuit is configured to convert a high-level voltage input of a high-voltage power supply into a low-level voltage output.

3. The high-voltage input power supply line applicable to the light-emitting load according to claim 2, wherein an output range of the high-level voltage is 6 to 230 V.

4. The high-voltage input power supply line applicable to the light-emitting load according to claim 2, wherein the low-level voltage is not less than a rated voltage of the plurality of cascaded light-emitting loads.

5. The high-voltage input power supply line applicable to the light-emitting load according to claim 4, wherein an output range of the low-level voltage is 3 to 36 V.

6. The high-voltage input power supply line applicable to the light-emitting load according to claim 1, wherein in all the light-emitting loads, the light-emitting control modules control circuits in the light-emitting modules to be on and off by using an I/O port of a single-chip microcomputer.

7. The high-voltage input power supply line applicable to the light-emitting load according to claim 1, wherein the plurality of cascaded light-emitting loads connected to the voltage reduction circuit are in signal communication with the voltage reduction circuit; when the voltage reduction circuit receives an operation control signal of the previous voltage reduction module, the voltage reduction circuit sends the operation control signal to the plurality of cascaded light-emitting loads connected to the voltage reduction circuit, so that the light-emitting control modules in the light-emitting loads control, on the basis of the operation control signal, the light-emitting modules to be on and off.
